(19) United States
(12) Patent Application Publication
(10) Pub. No.: US 2024/0109077 A1
(43) Pub. Date: Apr. 4, 2024

(54) SYSTEM AND METHOD FOR CAPTURING CARBON TO REMOVE CARBON DIOXIDE FROM THE ATMOSPHERE

(71) Applicants: Harrison Zack Rice, Honolulu, HI (US); R. Barrett Kotnik, Oswego, IL (US)

(72) Inventors: Harrison Zack Rice, Honolulu, HI (US); R. Barrett Kotnik, Oswego, IL (US)

(21) Appl. No.: 17/958,306

(22) Filed: Sep. 30, 2022

(51) Int. Cl. B03C 3/014; B01D 53/14; B01D 53/18; B03C 3/16

(52) U.S. Cl. CPC B03C 3/014; B01D 53/1425; B01D 53/1431; B01D 53/1475; B01D 53/18; B03C 3/16

(57) ABSTRACT

A carbon capture system using an efficient method of capturing carbon dioxide is disclosed herein. The carbon capture system described is scalable in shape and size and can be adjusted to achieve different volumes of airflow. This method is efficient due to the maximum surface area to volume ratio achievable in a carbon capture system with the distribution of equally or randomly spaced spray nozzles configured to inject electrically charged carbon capture fluid throughout the interior of the system. The fluid interacts and then combines with air and as a result, large amounts of carbon dioxide are captured within the system. The finer the particulate of carbon capture fluid, the larger the volume ratio which results in an efficient carbon capture system.

### BACKGROUND

Scientists studying the earth's atmosphere believe the earth is undergoing a long-term warming event referred to as global warming. This warming trend has been underway for quite some time, but its pace has increased significantly due to the burning of fossil fuels and other contributors to greenhouse gases. These greenhouse gases which are carbon dioxide, chloroflourocarbons, water vapor, methane, and nitrous oxide prevent heat from leaving the atmosphere which leads to global warming. To reverse this trend on a global scale there is a need for large scale systems capable of cleaning the atmosphere by efficiently removing excess carbon dioxide from the air. Current systems are based on repurposed industrial air conditioners which are not efficient since carbon dioxide capture is not maximized. In addition, current systems are filled industrial scrubbers which composed of expensive packing that is both cost prohibitive to scale exponentially and limiting in terms of how fast such systems can run. There is a need in the art for an efficient, fast operating carbon capture system in which a maximum amount of carbon dioxide is removed from the atmosphere.

### SUMMARY OF THE INVENTION

In accordance with a first embodiment of the invention, provided is a carbon capture system comprising: a) a structure b) a first intake configured to move air into said structure c) a charged carbon capture fluid for distribution within said structure d) a distribution element configured to distribute said charged carbon capture fluid inside said structure and e) a charged capture element configured to capture said charged carbon capture fluid, wherein said charged capture element is attached to said structure. The distribution element comprises at least one spray nozzle to distribute said charged carbon capture fluid into said air of said structure. In addition, said carbon capture system discussed above, wherein said distribution element comprises at least one liquid dispersion element to distribute said charged carbon capture fluid into said air of said structure. The charged distribution element d) further comprising at least one pipe containing said charged carbon capture fluid, said at least one pipe enabling said charged carbon capture fluid to flow into said structure. The carbon capture system, further comprising an electrically charged element to create said charged carbon capture fluid, wherein said electrically charged element is internal to said structure. The charged distribution element of d) above, wherein said electrically charged element is external to said structure, wherein said charged capture element has an opposite polarity to said charged carbon capture fluid, wherein said charged carbon capture fluid maintains a magnitude of charge.

In another embodiment provided is a carbon capture system comprising: a) an enclosure b) a first intake configured to intake air into said enclosure c) an electrically charged carbon capture fluid for distribution within said enclosure d) a distribution element configured to distribute said electrically charged carbon capture fluid into said air inside said enclosure e) an electrically insulated mixer to facilitate flow of said charged carbon capture fluid inside said enclosure and f) an electrically charged capture element having at least one fan with an opposing electrical charge from said electrically charged carbon capture fluid such that said electrically charged carbon capture fluid bonds to said fan when passing through said fan. In addition, the carbon capture system in the embodiment discussed above, wherein said electrically charged capture element comprises an inner portion and an outer portion and said fan extends across said inner portion into said outer portion. Furthermore, the carbon capture system in the embodiment discussed above, wherein said electrically charged capture element, further comprises: a) an inner housing containing at least one fan having a curved end point on a plurality of fan blades b) an outer housing to collect said electrically charged carbon capture fluid and c) a plurality of slats between said inner and said outer housing configured to allow said fans to protrude into said outer housing. In addition, a distribution element comprises at least one spray nozzle configured to disperse said electrically charged carbon capture fluid into said air within said enclosure, wherein said distribution element comprises at least one spray nozzle for dispersing said electrically charged carbon capture fluid into said air. In addition, in this embodiment, wherein said distribution element comprises a plurality of spray nozzles for dispersing said electrically charged carbon capture fluid into said air, wherein said plurality of spray nozzles are spaced for relatively even distribution of said electrically charged carbon capture fluid into said air. The carbon capture system in the embodiment discussed above, further comprising a) piping that carries an electrical charge to maintain a magnitude of charge of said electrically charged carbon capture fluid, wherein said electrically charged capture element utilizes an opposite polarity to said electrically charged carbon capture fluid. In addition, in the embodiment discussed above, wherein said electrically insulated mixer comprises a paddle also wherein said electrically insulated mixer comprises a rotor, wherein said electrically insulated mixer comprises a fan and wherein said at least one fan captures said electrically charged carbon capture fluid on said curved end point on said plurality of fan blades via centrifugal force.

In another embodiment provided is a carbon capture system comprising: a) a structure b) a first intake configured to move air into said structure c) a carbon capture fluid for distribution within said structure d) a distribution element configured to distribute said carbon capture fluid inside said structure e) an exhaust particle separating centrifuge, wherein said exhaust particle separating centrifuge is attached to said structure f) an impeller, wherein said impeller pulls in air and said carbon capture fluid through said structure, wherein said impeller is attached to said exhaust particle separating centrifuge g) a clean air exhaust pipe, wherein said clean air exhaust pipe is attached to said structure, wherein clean air from said structure goes through said clean air exhaust pipe and h) a combined clean air exhaust pipe, wherein a plurality of said clean air exhaust pipes attach to said combined clean air exhaust pipe, wherein air is collected in said combined clean air exhaust pipe, wherein air leaves said combined clean air exhaust pipe.

Provided is a centrifuge impeller system comprising: a) an impeller, wherein said impeller moves air through a structure b) a second intake, wherein air from said structure enters said a second intake c) a first fixed blade, wherein air is redirected with centrifugal motion via said first fixed blades d) a second fixed blade, wherein air is directed out of centrifugal motion and into a direct airflow from said second fixed blades towards said impeller e) an apex turn, wherein said apex turn abruptly turns air towards said impeller f) a first collection area, wherein a plurality of particulate is collected in said first collection area g) a second collection area, wherein said particulate is collected via gravity in said second collection area h) a recirculation pipe, wherein carbon dioxide filled air is circulated back into said structure via said recirculation pipe i) an electric motor, wherein said motor gives power to said impeller and j) a clean air exhaust pipe, wherein said clean air exhaust pipe is attached to said structure, wherein clean air from said structure goes through said clean air exhaust pipe.

Provided is a method of capturing carbon comprising: a) intaking air into a structure for cleansing of carbon dioxide then b) charging a carbon capture fluid into a charged carbon capture fluid then c) injecting said charged carbon capture fluid into said air within said structure then d) capturing said charged carbon capture fluid on an air mixing component to capture said carbon dioxide from said air and e) separating said charged carbon dioxide from said air with a capture element having an opposing electrical charge to said carbon capture fluid. In addition, the method discussed above further comprising: a) reusing said carbon capture fluid, wherein said charged carbon capture fluid is collected and injected back into said structure, wherein said air mixing component is a fan having an opposite polarity to said charged carbon capture fluid. The method described above further comprising: a) moving said air within said structure with an air stirring component, wherein said air stirring component is electrically insulated, wherein said air stirring component is a paddle and, and wherein said air stirring component is a fan.

In another embodiment, provided is a method of capturing carbon comprising: a) intaking air into an enclosure then b) charging carbon capture fluid with an electrical charge to form a charged carbon capture fluid then c) injecting said charged carbon capture fluid into said enclosure via a fluid entry component then d) stirring said charged carbon capture fluid in said enclosure via an electrically insulated air stirring component then e) capturing carbon dioxide from said air into said charged carbon capture fluid and f) circulating said charged carbon capture fluid holding said carbon dioxide through a release component holding an opposite charge from said charged carbon capture fluid to release said carbon dioxide into a holding reservoir. The method in the embodiment discussed above further comprising: a) releasing said carbon dioxide into an outer housing, wherein said carbon dioxide is released into said outer housing through centrifugal force, and wherein said release component comprises at least one fan configured to an opposite polarity of said charged carbon capture fluid to attract said charged carbon capture fluid. The method the embodiment discussed above further comprising: a) reusing said carbon capture fluid, wherein said charged carbon capture fluid is collected and injected back into said structure.

### DESCRIPTION OF THE DRAWINGS

FIG. 1 illustrates the components of a system for capturing carbon to remove carbon dioxide from the atmosphere as configured in accordance with one or more embodiments of the invention.

FIG. 2 illustrates a top view of the system of capturing carbon to remove carbon dioxide from the atmosphere as configured in accordance with one or more embodiments of the invention.

FIG. 3 illustrates a spray nozzle configuration within a distribution element utilized within the system in accordance with one or more embodiments of the invention.

FIG. 4 illustrates a charged carbon capture element with a fan or fans as configured in accordance with one or more embodiments of the invention.

FIG. 5 illustrates another embodiment of capturing carbon to remove carbon dioxide from the atmosphere. In this embodiment the charged capture element is not attached to the structure.

FIG. 6 illustrates another embodiment of capturing carbon to remove carbon dioxide from the atmosphere. In this embodiment an inlet particle separator is used with an impeller to pull in and capture carbon dioxide from the electrically charged carbon capture fluid particulate.

FIG. 7 illustrates a method for capturing carbon to remove carbon dioxide from the atmosphere as configured in accordance with one or more embodiments of the invention.

FIG. 8 illustrates another embodiment of a method for capturing carbon to remove carbon dioxide from the atmosphere.

FIG. 9 illustrates another embodiment of the top view of the carbon capture system implemented with an exhaust particle separating centrifuge, impeller and exhaust pipes used to push clean air out of the structure into the atmosphere.

FIG. 10 illustrates an exhaust particle separator centrifuge, impeller, and exhaust pipes.

### DETAILED DESCRIPTION

A system and method for capturing carbon to remove carbon dioxide from the atmosphere will now be described in accordance with one or more embodiments of the invention. In the following exemplary description numerous specific details are set forth to provide a more thorough understanding of embodiments of the invention. It will be apparent, however, to an artisan of ordinary skill that the present invention may be practiced without incorporating all aspects of the specific details described herein. Furthermore, although steps or processes are set forth in an exemplary order to provide an understanding of one or more systems and methods, the exemplary order is not meant to be limiting. One of ordinary skill in the art would recognize that the steps or processes may be performed in a different order, and that one or more steps or processes may be performed simultaneously or in multiple process flows without departing from the spirit or the scope of the invention. In other instances, specific features, quantities, or measurements well known to those of ordinary skill in the art have not been described in detail so as not to obscure the invention. It should be noted that although examples of the invention are set forth herein, the claims, and the full scope of any equivalents, are what define the metes and bounds of the invention.

For a better understanding of the disclosed embodiment, its operating advantages, and the specified object attained by its uses, reference should be made to the accompanying drawings and descriptive matter in which there are illustrated exemplary disclosed embodiments. The disclosed embodiments are not intended to be limited to the specific forms set forth herein. It is understood that various omissions and substitutions of equivalents are contemplated as circumstances may suggest or render expedient, but these are intended to cover the application or implementation.

The term “first”, “second” and the like, herein do not denote any order, quantity or importance, but rather are used to distinguish one element from another, and the terms “a” and “an” herein do not denote a limitation of quantity, but rather denote the presence of at least one of the referenced items.

Spatially relative terms, such as “beneath,” “below,” “lower,” “under,” “above,” “upper,” and the like, may be used herein for ease of explanation to describe one element or feature's relationship to another element(s) or feature(s) as illustrated in the figures. It will be understood that the spatially relative terms are intended to encompass different orientations of the device in use or in operation, in addition to the orientation depicted in the figures. For example, if the device in the figures is turned over, elements described as “below” or “beneath” or “under” other elements or features would then be oriented “above” the other elements or features. Thus, the example terms “below” and “under” can encompass both an orientation of above and below. The device may be otherwise oriented (e.g., rotated 90 degrees or at other orientations) and the spatially relative descriptors used herein should be interpreted accordingly.

It will be understood that when an element or layer is referred to as being “on,” “connected to,” or “coupled to” another element or layer, it can be directly on, connected to, or coupled to the other element or layer, or one or more intervening elements or layers may be present. In addition, it will also be understood that when an element or layer is referred to as being “between” two elements or layers, it can be the only element or layer between the two elements or layers, or one or more intervening elements or layers may also be present.

As used herein, the term “substantially,” “about,” and similar terms are used as terms of approximation and not as terms of degree, and are intended to account for the inherent deviations in measured or calculated values that would be recognized by those of ordinary skill in the art. Further, the use of “may” when describing embodiments of the present invention refers to “one or more embodiments of the present invention.” As used herein, the terms “use,” “using,” and “used” may be considered synonymous with the terms “utilize,” “utilizing,” and “utilized,” respectively. Also, the term “exemplary” is intended to refer to an example or illustration.

Unless otherwise defined, all terms (including technical and scientific terms) used herein have the same meaning as commonly understood by one of ordinary skill in the art to which the present invention belongs. It will be further understood that terms, such as those defined in commonly used dictionaries, should be interpreted as having a meaning that is consistent with their meaning in the context of the relevant art and/or the present specification, and should not be interpreted in an idealized or overly formal sense, unless expressly so defined herein.

References. The description of the figures provided herein contain references to each depicted component. A list of these components described in the context of each figure is provided below for easy reference.

| | |
|---|---|
| 100 | Structure |
| 102 | First Intake |
| 104 | Electrically insulated Mixer |
| 106 | Distribution Element |
| 108 | Electrically Charged or Neutral Carbon Capture Fluid |
| 110 | Charged Capture Element |
| 112 | Air from the Atmosphere |
| 114 | Air inside structure |
| 116 | Electrically Insulated Paddle |
| 118 | Carbon Capture Fluid Mixes with Air |
| 120 | Resultant Particulate |
| 122 | Fans |
| 124 | Residuary Air |
| 126 | Carbon Capture Fluid reused |
| 200 | Grate |
| 300 | Spray Nozzles |
| 302 | Pipes |
| 400 | Holding Reservoir |
| 402 | Curved Point of the Fan |
| 404 | Outer Housing |
| 406 | Inner Housing |
| 600 | Exhaust particle separating centrifuge |
| 602 | Impeller |
| 700 | Intaking Air |
| 702 | Charging Carbon Capture Fluid |
| 704 | Injecting Carbon Capture Fluid into Structure |
| 706 | Capturing Carbon Dioxide from Air |
| 708 | Separating Carbon Dioxide from Air |
| 710 | Moving Air within the Structure |
| 712 | Reusing Carbon Capture Fluid |
| 800 | Stirring Air and Carbon Capture Fluid |
| 802 | Circulating Carbon Capture Fluid |
| 804 | Releasing Carbon Dioxide into the Outer Housing |
| 900 | Clean Air Exhaust Pipe |
| 902 | Combined Clean Air Exhaust Pipe |
| 1000 | Second Intake |
| 1002 | First Fixed Blades |
| 1004 | Apex Turn |
| 1006 | Second Fixed Blades |
| 1008 | First Collection Area |
| 1010 | Second Collection Area |
| 1012 | Recirculating Pipe |
| 1014 | Electric Motor |
| 1016 | Cone |

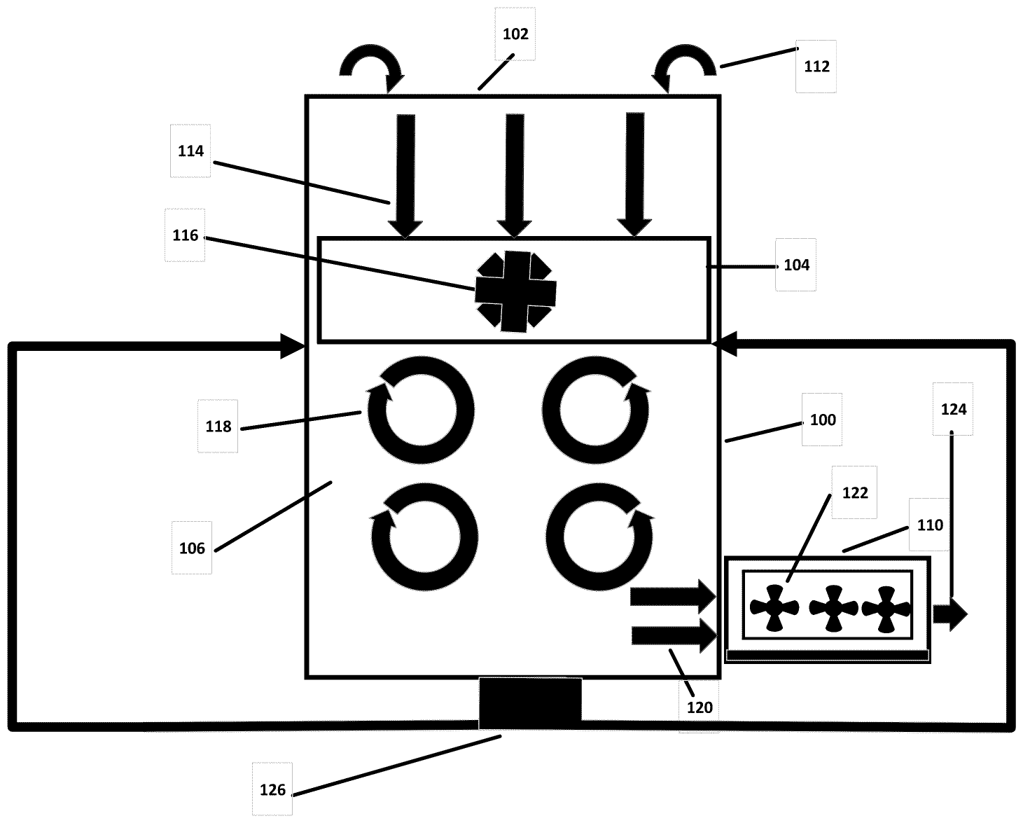

FIG. 1 illustrates the components of a system for capturing carbon to remove carbon dioxide from the atmosphere as configured in accordance with one or more embodiments of the invention. The system is typically contained within a structure (100) of sorts built to house the various system components. Structure (100) here can include but is not limited to enclosure, housing and system. This structure (100) provides an enclosure within which other system elements are contained and may take various shapes and sizes dependent upon the volume of air to be processed by the system. In accordance with one or more embodiments of the invention, this structure (100) comprises a first intake (102), an electrically insulated mixer (104) a distribution element (106), carbon capture fluid (108), and a charged capture element (110). The air from the atmosphere (112) enters the structure (100) through the first intake (102). The first intake (102) is not limited to any specific shape or structure so long as the first intake (102) is built in a way that enables airflow while minimizing the ability for debris from outside to enter the structure (100). The electrically insulated mixer (104), which is comprised of an electrically insulated paddle (116), allows the carbon capture fluid to flow into the distribution element (106) via pipes (302). The electrically insulated mixer (104) is not limited to an electrically insulated paddle (116) and can also be implemented with an equivalent mixing mechanism. The electrically insulated mixer (104) can be abutted to a distribution element (106) which is comprised of an array of spray nozzles (300) that spray electrically charged carbon capture fluid (108) throughout the structure (100). The carbon capture fluid (108) is not limited to an electrical charge and can be configured to have a neutral charge.

However, in this embodiment, the carbon capture fluid (108) is configured to be electrically charged. The distribution element (106) is not limited to spray nozzles (300) and can instead be comprised of any apparatus that's able to distribute a liquid within the distribution element (106). The plurality of spray nozzles (300) or equivalent liquid distribution apparatus can be arranged in any manner or pattern. The spray nozzles (300) can be either equidistant or randomly spaced within the distribution element (106). The equidistant property of the spray nozzles (300) allows for the maximum distribution of the electrically charged carbon capture fluid (108). The carbon capture fluid (108) which relies upon liquid contactors, also known as solvents, where the carbon dioxide is absorbed into a liquid solution, can be made with but is not limited to: primary amines such as monoethanolamine (MEA), isobutylamine (IBA), ethylamine, propylamine, secondary amines such as diethanolamine (DEA), piperazine (PZ), diisopropylamine (DIPA), 2-methylaminoethanol (MAE) tertiary amines such as tetraethylenepentamine (TEPA), N-methyldiethanolamine (MDEA), 2-(dimethylamino) ethanol (DMEA), N-diethylethanolamines (DEEA), 2-amino-1-methyl-2-propanol (AMP), aqueous solutions with ionic concentration such as potassium hydroxide (KOH), sodium hydroxide (NaOH) or any equivalent liquid. Before the electrically charged carbon capture fluid (108) is sprayed throughout the structure (100), it is initially injected externally or internally into the structure (100). The electrically charged carbon capture fluid (108) is blocked from leaving the electrically insulated mixer (104) because of the electrically insulated paddle (116). The blocking of the electrically charged carbon capture fluid (108) is not limited to the electrically insulated paddle (116) but can be also achieved by any other blocking mechanism such as a fan or another equivalent structure which stops the electrically charged carbon capture fluid (108) from leaving the electrically insulated mixer (104). The sprayed electrically charged carbon capture fluid (108) that comes out of the array of spray nozzles (300), interacts and mixes with air (118) within the distribution element (106). The mixing or stirring of air inside the structure (118) and the electrically charged capture fluid (108) results in the trapping of carbon dioxide from the air inside the structure (114) within the distribution element (106). The stirring or mixing of air inside the structure (118) and the electrically charged carbon capture fluid (108) can be achieved with either air or with the electrically insulated paddle (116). The resultant particulate (120) is then captured by a charged capture element (110), which can be placed inside or outside of the structure (100). The charged capture element (110) is comprised of either a single or a plurality of fans (122). The fan or fans (122) within the charged carbon capture element (110) helps push out residuary air (124) and store captured carbon dioxide. The charged capture element (110) is also configured to have a charge opposite polarity to the charge of the particulate (120) that is distributed throughout the distribution element (106). The charged capture element (110) is not just limited to a fan or fans (122) and the polarity of the charged capture element (110). The charged capture element (110) can be configured to function with only fans (122) or only electrical charge in order to attract the resultant particulate (120). The charged capture element (100) can be any particulate capturing mechanism. The captured carbon dioxide remains within the charged capture element (110) and the residuary air (124) flows out of the charged capture element (110). The residuary air (124) can flow out of the charged capture element (110) with or without the assistance of fans (122) and clean air exhaust pipes (900). The remaining electrically charged carbon capture fluid (108) is collected and reused (126) by the structure (100). The carbon capture system can be configured to not reuse (126) the remaining electrically charged carbon capture fluid (108). Instead, the carbon capture system can dump or store the remaining electrically charged carbon capture fluid (108).

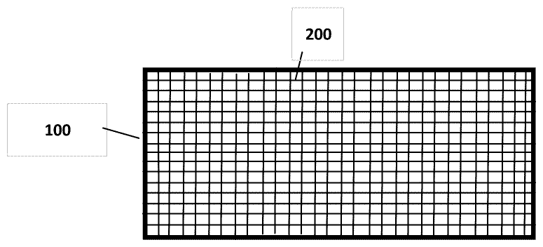

FIG. 2 illustrates the top view of the carbon capture system. The first intake (102) of the structure (100) includes a grate (200) which can be attached to the structure (100). The grate (200) is not limited to a shape or pattern and can be configured to allow air from the atmosphere (112) to enter the structure (100) while not allowing debris to enter the structure (100). In addition, the first intake (102) can be configured without the use of the grate (200). Examples of other types of grates (200) shapes that can be used in the first intake (102) are triangular, rectangular, circular or any other polygon that can be configured to be a grate (200).

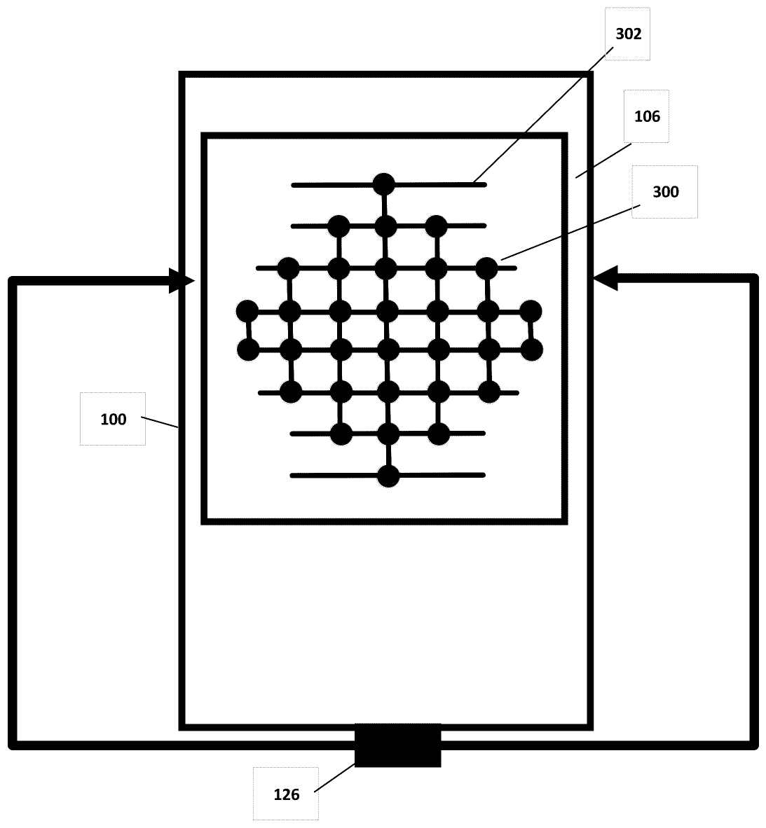

FIG. 3 illustrates the components of the distribution element (106) as configured in accordance with one or more embodiments of the invention. The system is typically contained within a structure (100) of sorts built to house the various system components. The distribution element (106) is comprised of a plurality of pipes (302), and a plurality of spray nozzles (300). The distribution element (106) is not limited to pipes (302) and spray nozzles (300) but can be configured as a liquid distribution network, which distributes liquid throughout the system. The spray nozzles (300) can be arranged in any manner or pattern. Adjacent nozzles (300) can be spaced equidistantly or randomly from each other. The equidistant property of the spray nozzles (300) allows for the maximum distribution of the electrically charged carbon capture fluid (108). As electrically charged carbon capture fluid (108) is injected into the structure (100), it enters the pipes (102) or any other kind of entry mechanism in which the electrically charged carbon capture fluid (108) enters the structure (100). The pipes (302) then carry the electrically charged carbon capture fluid (108) to each of the spray nozzles (300) within the distribution element (106). In addition, the pipes (302) are configured to minimize the loss of charge of the electrically charged carbon capture fluid (108). This can be accomplished by making the pipes (302) out of an insulator-based material such that the electrically charged carbon capture fluid (108) does not lose significant amount of charge as it is distributed throughout the distribution element (106). The pipes (302) can also be configured to be made from conductor type materials. The minimization of charge loss will allow the electrically charged carbon capture fluid (108) to capture more carbon dioxide from the air inside the structure (114). The more carbon dioxide is captured from the air inside the structure (114) the more efficient the carbon capture system is. Within the distribution element (106) the air within the structure (114) and the electrically charged carbon capture fluid (108) interact and mix (118) resulting in a particulate (120). The resultant particulate (120) is a combination of air and electrically charged carbon capture fluid (108). In addition, carbon dioxide is also contained in the particulate (120) because the carbon dioxide was in the air from the atmosphere (112) as it entered the structure (100). The more resultant particulate (120) is produced within the distribution element (106), the more carbon dioxide can be captured.

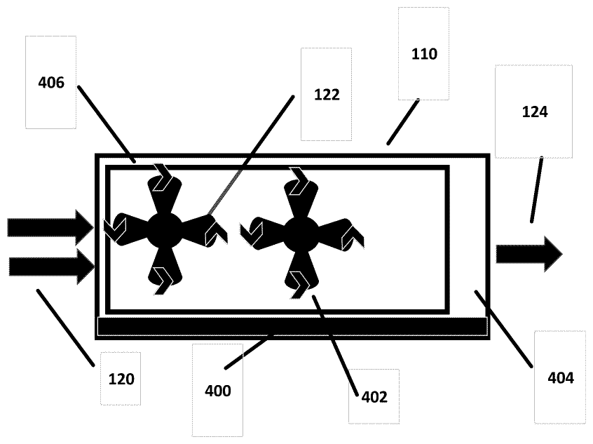

FIG. 4 illustrates a charged capture element (110), which is comprised of but not limited to a fan or a plurality of fans (122), a holding reservoir (400), a curved point of the fan (402), an outer housing (404) and an inner housing (406). The charged capture element (110) can be attached to the structure (100) and is configured to have an opposing electrical charge from the electrically charged carbon capture fluid (108) such that the resultant particulate (120) bonds to the fan or fans (122) when passing through the fan or fans (122). The charged carbon capture element (108) is not limited to the fans (122) and its charge within the structure (100). Instead, it can be configured to function with just the fan or fans (122) or just the electric charge when attracting the resultant particulate (120). As the resultant particulate (120) leaves the distribution element (106), it enters the charged capture element (110). In one embodiment, the fan or fans (122) pull in the resultant particulate (120) inside the charged capture element (110). The fan or fans (122) inside the charged capture element (110) extend across the inner portion of the housing (406) into the outer portion of the housing (404) within the charged capture element (110). The function of the outer housing (406) of the charged capture element (110) is to collect the resultant particulate (120), which is made up from electrically charged carbon capture fluid (108) and captured carbon dioxide, from the air inside the structure (114). The fan or fans (122), inside the charged capture element (110) have a curved end point at the fan ends (402). The curved point on the fan (402) is not limited to a distinct shape, but rather the fan (122) is configured such that it captures the maximum amount of resultant particulate (120). The curved point on the fan (402) captures the particulate (120) using centrifugal force. The holding reservoir (400) within the charged capture element (110) collects the remaining particulate (120). The charged capture element (110) is not limited to the holding reservoir (400) and can be instead configured to hold the resulting particulate in any alternate holding or storing mechanism. The resultant particulate (120) inside the holding reservoir (400) can be reused (126) by the structure (100). As stated, the resultant particulate (120) can be reused (126) or stored or discarded. The reuse of the particulate (126) allows the system to use all the left over particulate and not waste or discard any amount. The reuse (126) in turn allows the system to be more efficient.

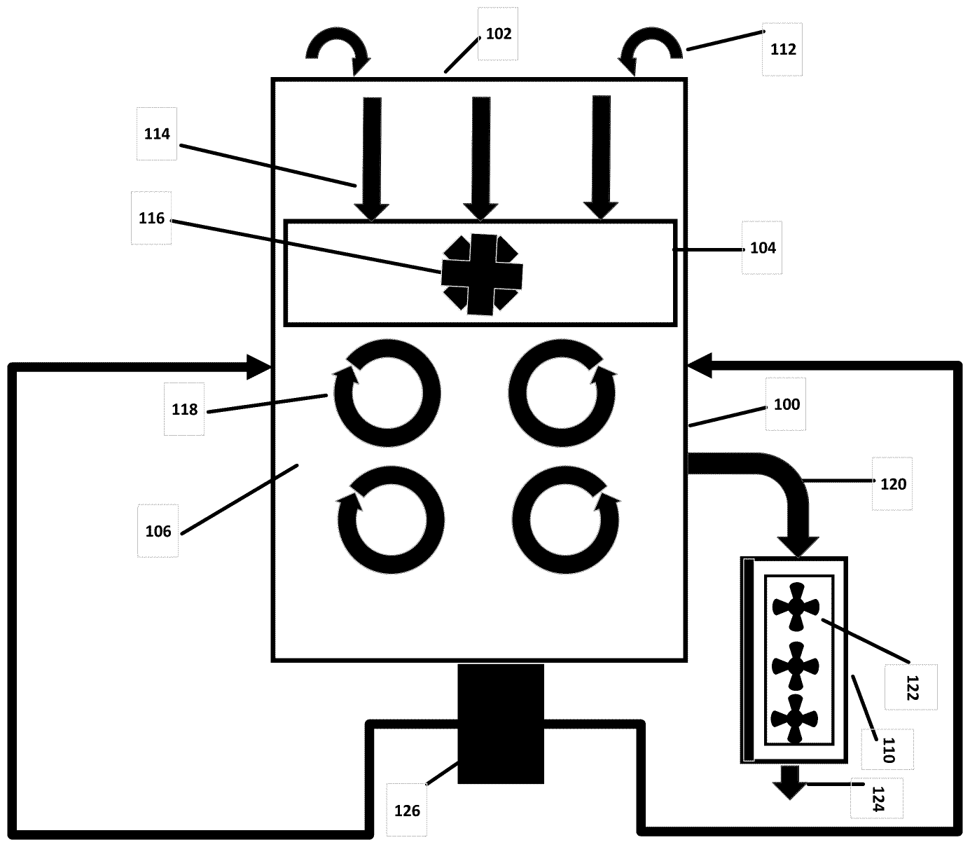

FIG. 5 illustrates another embodiment of the carbon capture system where the components of a system are contained within a structure (100) of sorts built to house the various system components. This structure (100) provides an enclosure within which other system elements are contained and may take various shapes and sizes dependent upon the volume of air to be processed by the system. The structure (100) comprises of a first intake (102), an electrically insulated mixer (104) a distribution element (106), an electrically charged carbon capture fluid (108), and a charged capture element (110). In this embodiment, the charged capture element (110) is not abutted to the structure (100) but rather spaced away from the structure (100) in a vertical orientation which allows the resultant particulate (120), that comes out of the distribution element (106) within the structure (100), to be removed via centrifugal force. The resultant particulate (120) is then collected outside the structure (100) and from that point gravity pulls the particulate (120) downward into the charged capture element (110).

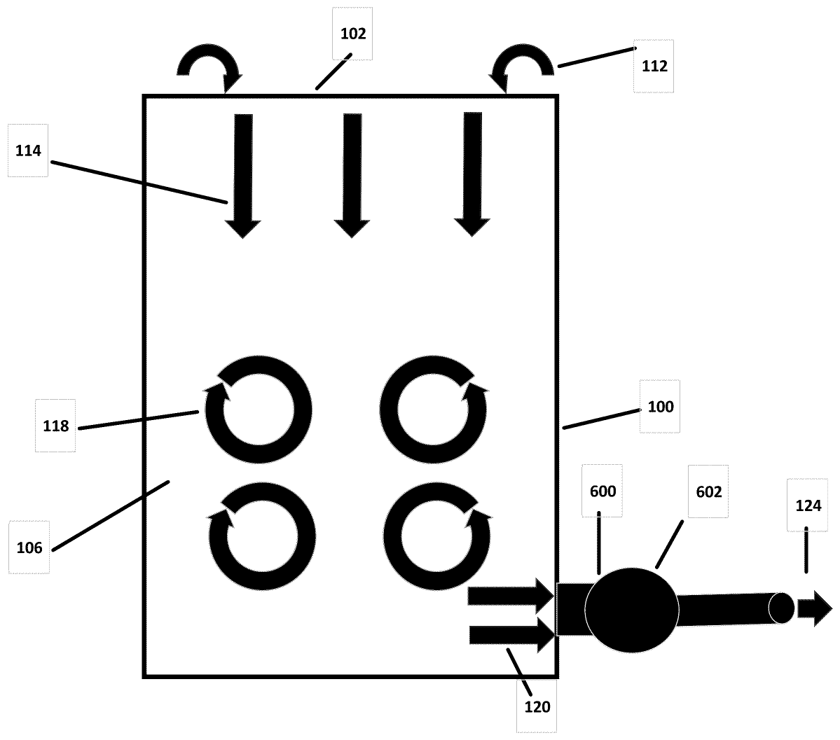

FIG. 6 illustrates an alternate embodiment of the carbon capture system where the components of a system are contained within a structure (100) of sorts built to house the various system components. This structure (100) provides an enclosure within which other system elements are contained and may take various shapes and sizes dependent upon the volume of air to be processed by the system. The structure (100) comprises of a first intake (102), a distribution element (106), a carbon capture fluid (108), an exhaust particle separating centrifuge (600) and an impeller (602). The exhaust particle separating centrifuge (600) can be attached to the structure (100) on one side and attached to the impeller (602) on the other side. The exhaust particle separating centrifuge (600) and the impeller (602) both create suction in the structure (100) and remove particulate (120) from the air that is inside the structure (114). After the particulate (120) is separated from the air, air leaves the structure (100) via the impeller (602). Specifically in this embodiment the exhaust particle centrifuge (600) and the impeller (602) form an exhaust stream that will take in a plurality of particulate (120) from the air inside the structure (114). After the air from the structure (114) is separated from the carbon capture fluid (108), it is then pulled into the impeller (602) where the residuary air (124) is pushed out of the structure (100). The residuary air (124) that is pushed out of the structure (100) will mix back into the atmosphere free from carbon dioxide. Although the carbon capture fluid (108) would still benefit from a charge, in this embodiment, there is no charge requirement on the tail end of the structure (100) nor is charge required for the carbon capture fluid (108). Instead of relying on charge, the carbon capture system in this embodiment will capture the carbon capture fluid (108) with an exhaust particle separation centrifuge (600) and impeller (602) via centrifugal force, wherein air from the atmosphere (112) is pulled into the structure (100) at a high velocity via exhaust particle separation centrifuge (600) and impeller (602).

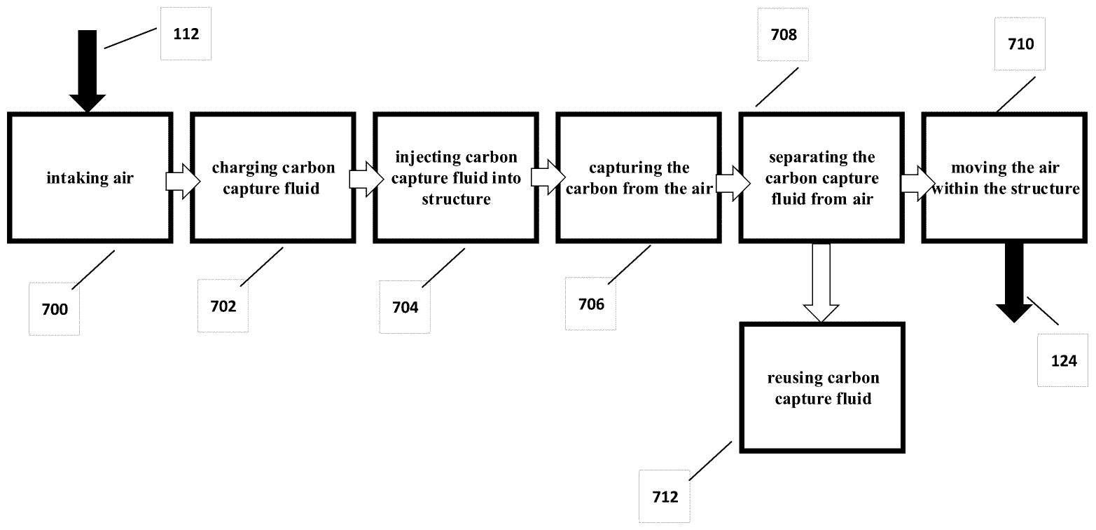

FIG. 7 illustrates a method of capturing carbon dioxide from the atmosphere. The method in this embodiment comprises of first intaking air (700) from the atmosphere (112) into a structure (100). After intaking air from the atmosphere (112), carbon capture fluid (108) is charged (702), either inside the structure (100) or within the structure (100), to form an electrically charged carbon capture fluid (108). After the charging of the carbon capture fluid (702), the electrically charged carbon capture fluid (108) is injected (704) into the structure (100). The next step requires capturing (706) the electrically charged carbon capture fluid (108) from the air inside the structure (114). After capturing (706) the electrically charged carbon capture fluid (108), the next step requires separating (708) the carbon dioxide from the air inside the structure (114) with a charged capture element (110) that is configured to have an opposing electrical charge in comparison to the electrically charged carbon capture fluid (108). In one configuration an exhaust particle separating centrifuge (600) can be used to separate the electrically charged carbon capture fluid (108) from the air that is inside the structure (114) at a high velocity. After the air from the structure (114) is separated from the electrically charged carbon capture fluid (108) it is then pulled into the impeller (602) or any other functionally equivalent mechanism.

In another embodiment fan or fans (122) pull in the resultant particulate (120) inside the charged capture element (110). The fan or fans (122) inside the charged capture element (110) extend across the inner portion of the housing (406) into the outer portion of the housing (404) within the charged capture element (110). The function of the outer housing (406) of the charged capture element (110) is to collect the resultant particulate (120). The collection of the resultant particulate (120) can be achieved using any collection method. Once the carbon dioxide is captured (706) in the charged capture element (110), the air in the structure (114) is moved out of the structure (100). The structure may (100) reuse (126) the left-over carbon capture fluid (108) throughout the process of capturing carbon dioxide from the air inside the structure (114). The reusing (712) of the carbon capture fluid (108) can be achieved either continuously, incrementally, or the carbon capture fluid (108) can be stored or discarded. In addition, the reusing (712) of the carbon capture fluid (108) can be done automatically, manually or randomly.

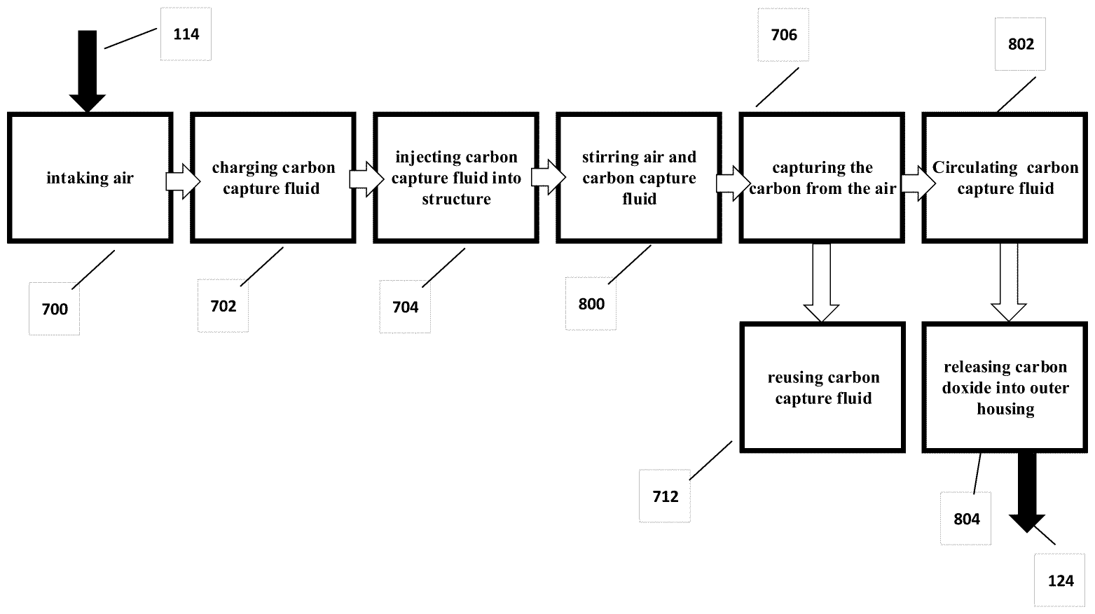

FIG. 8 illustrates another embodiment of a method of capturing carbon dioxide from the atmosphere. The method in this embodiment comprises of intaking air (700) into the structure (100), then the electrically charged carbon capture fluid (108) is charged (702), either inside the structure (100) or within the structure (100), to form an electrically charged carbon capture fluid (108). After the charging of the electrically charged carbon capture fluid (108), the fluid (108) is injected (704) into the structure (100). The next step requires stirring (800) the electrically charged carbon capture fluid (108) in the structure (100) via an electrically insulated mixer (104) and electrically insulated paddle (116). The electrically insulated mixer (104) is not limited to only an electrically insulated paddle (116) and can also be implemented with a fan or fans (122), an electric motor (1014) or an equivalent mixing mechanism. After stirring (800), the next step requires capturing (706) the electrically charged carbon capture fluid (108) in order to capture carbon dioxide from the air inside the structure (114). The next step requires circulating (802) the electrically charged carbon capture fluid (108), and then holding the carbon dioxide. The held carbon dioxide is then released (804) into a holding reservoir (400). The carbon dioxide is then released into an outer housing (404) through centrifugal force. The carbon capture system may reuse (712) the left-over electrically charged carbon capture fluid (108) throughout the process of capturing carbon dioxide from the air inside the structure (114). The reusing of the electrically charged carbon capture fluid (712) can be achieved either continuously or in incremental steps. In addition, the reusing (712) of the electrically charged carbon capture fluid (108) can be done automatically or randomly.

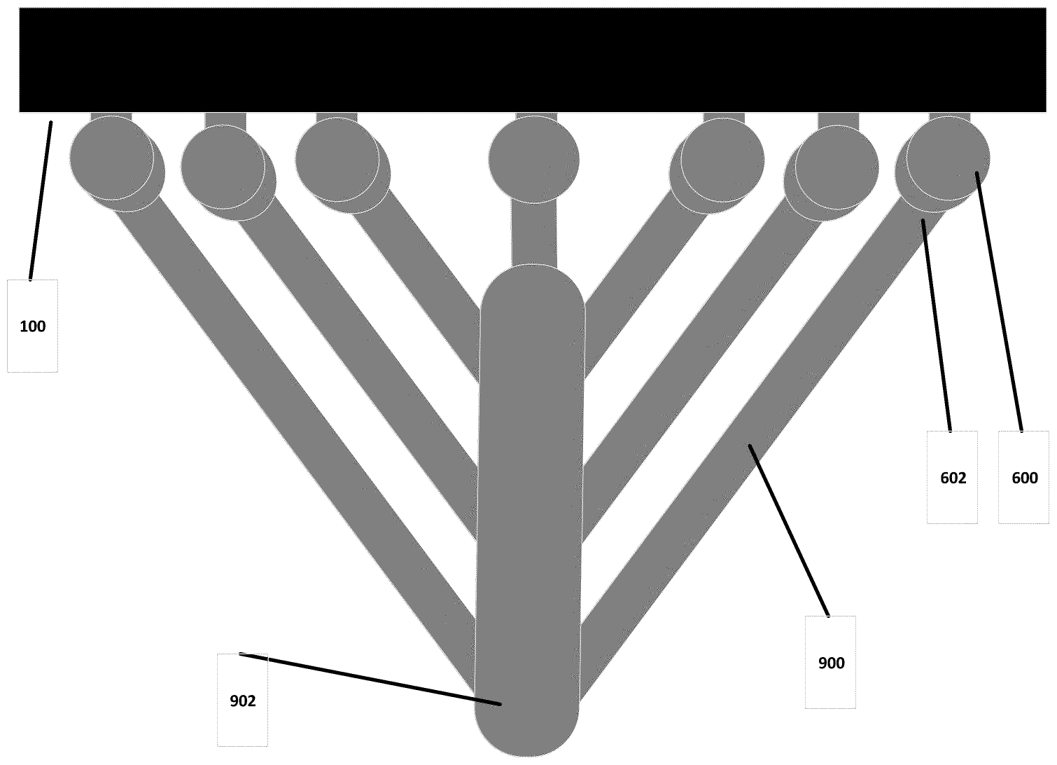

FIG. 9 illustrates another embodiment of the carbon capture system where the components of a system are contained within a structure (100) of sorts built to house the various system components. The shape of the structure can be any shape and size. In this embodiment it is shown as a rectangle. This structure (100) provides an enclosure within which other system elements are contained and may take various shapes and sizes dependent upon the volume of air to be processed by the system. The structure (100) comprises of a first intake (102), a distribution element (106), a carbon capture fluid (108), an exhaust particle separating centrifuge (600), an impeller (602), a clean air exhaust pipe (900) and a combined clean air exhaust pipe (902). The number of clean air exhaust pipes (900) or the number of combined clean air exhaust pipes (902) can vary from zero to as many as needed depending on the carbon capture system. Air mixed with carbon capture fluid particulate (118) passes from the structure (100) to second intake (1000) and is then directed via fixed blades (1002) into an exhaust particle separating centrifuge (600), driving particulate (120) to the perimeter of the exhaust particle separating centrifuge (600) via centrifugal force. Air inside the structure (114) then passes over the apex turn (1004), where air (114) is forced to make a sharper turn than the particulate (120). Air inside the structure (114) is then redirected straight and out of a centrifugal motion via second fixed blades (1006) before being pulled through the impeller (602) driving residuary air (124) through the system, powered by an electric motor (1014). Carbon capture fluid (108) flows into the first collection area (1008) and then a second collection area (1010) where Carbon capture fluid (108) drops to the bottom for collection as air flows incidentally with the carbon capture fluid (108). Air (124) is then redirected in front of the second intake (1000) via recirculation pipes (1012). After the air (124) is separated from the carbon capture fluid (108), it is then pulled into the impeller (602) where the now carbon dioxide free air is pushed out of the structure (100). The residuary air (124) that is pushed out of the structure will mix back into the atmosphere again.

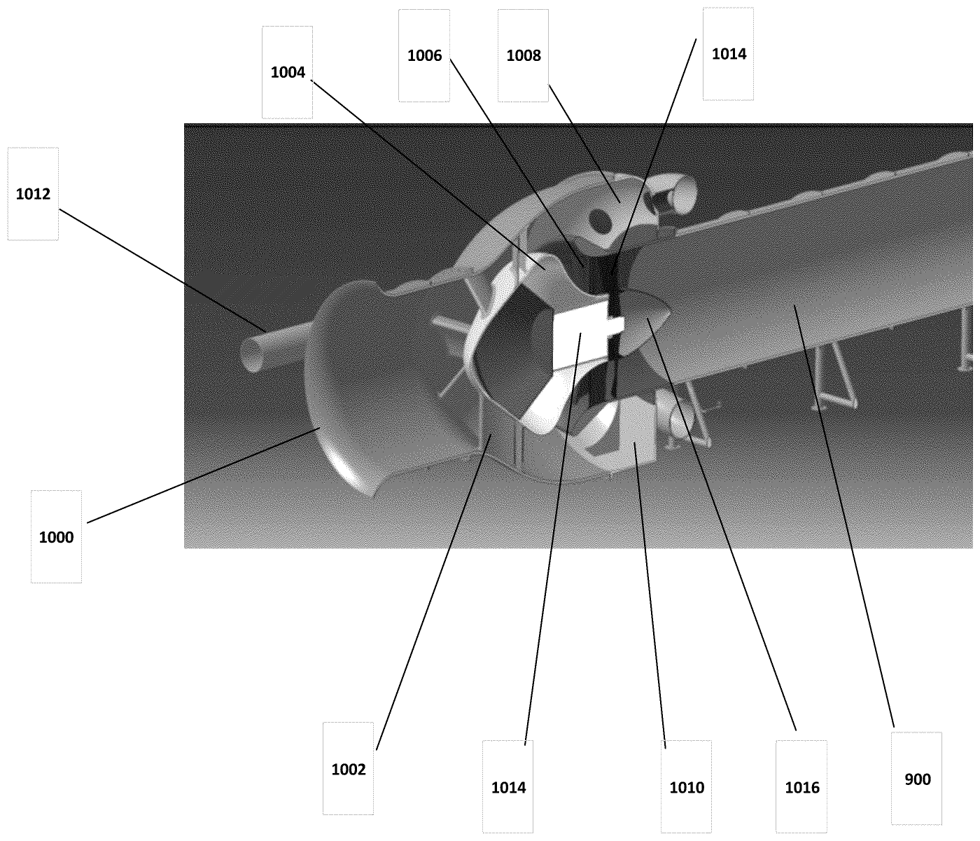

FIG. 10 illustrates the components of the exhaust particle separating centrifuge (600) and impeller (602). Air mixed with particulate (118) passes from the structure (100) to second intake (1000) and is directed, via first fixed blades (1002), into an exhaust particle separation centrifuge (600), driving particulate (120) to the perimeter of the exhaust particle separating centrifuge (600) via centrifugal force. The air (124) then passes over an apex turn (1004), where air is forced to make a sharper turn than the particulate (120). Air inside the structure (114) is then redirected straight and out of a centrifugal motion via second fixed blades (1006) before being pulled through an impeller (602). The impeller (602) drives air (124) through the structure (100) and is powered by an electric motor (1014). The particulate (120) then flows into a first (1008) and then to a second collection area (1010). Particulate (120) drops to the bottom for collection as air (124) flows incidentally with the carbon capture fluid (108). The air (124) is then redirected in front of the second intake (1000) via a single or a plurality of circulation pipes (1012). The recirculation pipes (1012) allow carbon dioxide filled air to exit and naturally flow back into the structure (100) to be cleaned again by the structure (100). If carbon dioxide is not removed from the air inside the structure (114), the uncleaned air will create drag and possibly disrupt or impair the airflow dynamics within the structure (100).

What is claimed is:

1. A carbon capture system comprising:
a structure;
a first intake configured to move air into said structure;
a charged carbon capture fluid for distribution within said structure;
a distribution element configured to distribute said charged carbon capture fluid inside said structure; and
a capture element configured to capture said carbon capture fluid, wherein said capture element is attached to said structure.

2. The carbon capture system of claim 1, wherein said distribution element comprises at least one spray nozzle to distribute said charged carbon capture fluid into said air of said structure.

3. The carbon capture system of claim 1, wherein said distribution element comprises at least one liquid dispersion element to distribute said charged carbon capture fluid into said air of said structure.

4. The charged distribution element of claim 4, further comprising at least one pipe containing said carbon capture fluid, said at least one pipe enabling said charged carbon capture fluid to flow into said structure.

5. The carbon capture system of claim 1, further comprising a charged element to create said charged carbon capture fluid.

6. The carbon capture system of claim 6, wherein said charged element is internal to said structure.

7. The charged distribution element of claim 1, wherein said charged element is external to said structure.

8. The carbon capture system of claim 1, wherein said capture element has an opposite polarity to said charged carbon capture fluid.

9. The carbon capture system of claim 1, wherein said charged carbon capture fluid maintains a magnitude of charge.

10. A carbon capture system comprising:
an enclosure;
a first intake configured to intake air into said enclosure;
an electrically charged carbon capture fluid for distribution within said enclosure;
a distribution element configured to distribute said electrically charged carbon capture fluid into said air inside said enclosure;
an electrically insulated mixer to facilitate flow of said charged carbon capture fluid inside said enclosure; and
an electrically charged capture element having at least one fan with an opposing electrical charge from said electrically charged carbon capture fluid such that said electrically charged carbon capture fluid bonds to said fan when passing through said fan.

11. The carbon capture system of claim 10, wherein said electrically charged capture element comprises an inner portion and an outer portion and said fan extends across said inner portion into said outer portion.

12. The carbon capture system of claim 10, wherein said electrically charged capture element, further comprises:
an inner housing containing at least one fan;
said at least one fan having a curved end point on a plurality of fan blades;
an outer housing to collect said electrically charged carbon capture fluid;
a plurality of slats between said inner and said outer housing configured to allow said fans to protrude into said outer housing and
an additive to said electrically charged carbon capture fluid that reacts to a magnetic field within said enclosure.

13. The carbon capture system of claim 10, wherein said distribution element comprises at least one spray nozzle configured to disperse said electrically charged carbon capture fluid into said air within said enclosure.

14. The carbon capture system of claim 10, wherein said distribution element comprises at least one spray nozzle for dispersing said electrically charged carbon capture fluid into said air.

15. The carbon capture system of claim 10, wherein said distribution element comprises a plurality of spray nozzles for dispersing said electrically charged carbon capture fluid into said air.

16. The carbon capture system of claim 15, wherein said plurality of spray nozzles are spaced for relatively even distribution of said electrically charged carbon capture fluid into said air.

17. The carbon capture system of claim 10, further comprising piping that carries an electrical charge to maintain a magnitude of charge of said electrically charged carbon capture fluid.

18. The carbon capture system of claim 10, wherein said electrically charged capture element utilizes an opposite polarity to said electrically charged carbon capture fluid.

19. The carbon capture system of claim 10, wherein said electrically insulated mixer comprises a paddle.

20. The carbon capture system of claim 10, wherein said electrically insulated mixer comprises a rotor.

21. The carbon capture system of claim 10, wherein said electrically insulated mixer comprises a fan.

22. The carbon capture system of claim 10, wherein said at least one fan captures said electrically charged carbon capture fluid on said curved end point on said plurality of fan blades via centrifugal force.

23. A carbon capture system comprising:
a structure;
a first intake configured to move air into said structure;
a carbon capture fluid for distribution within said structure;
a distribution element configured to distribute said carbon capture fluid inside said structure;
an exhaust particle separating centrifuge, wherein said exhaust particle separating centrifuge is attached to said structure;
an impeller, wherein said impeller pulls in air and said carbon capture fluid through said structure, wherein said impeller is attached to said exhaust particle separating centrifuge;
a clean air exhaust pipe, wherein said clean air exhaust pipe is attached to said structure, wherein clean air from said structure goes through said clean air exhaust pipe; and
a combined clean air exhaust pipe, wherein a plurality of said clean air exhaust pipes attach to said combined clean air exhaust pipe, wherein air is collected in said combined clean air exhaust pipe, wherein air leaves said combined clean air exhaust pipe.

24. A centrifuge impeller system comprising:
an impeller, wherein said impeller moves air through a structure;
a second intake, wherein air from said structure enters said a second intake;
a first fixed blade, wherein air is redirected with centrifugal motion via said first fixed blades;
a second fixed blade, wherein air is directed out of centrifugal motion and into a direct airflow from said second fixed blades towards said impeller;
an apex turn, wherein said apex turn abruptly turns air towards said impeller;
a first collection area, wherein a plurality of particulate is collected in said first collection area;
a second collection area, wherein said particulate is collected via gravity in said second collection area;
a recirculation pipe, wherein carbon dioxide filled air is circulated back into said structure via said recirculation pipe;
an electric motor, wherein said motor gives power to said impeller; and
a clean air exhaust pipe, wherein said clean air exhaust pipe is attached to said structure, wherein clean air from said structure goes through said clean air exhaust pipe.

25. A method of capturing carbon comprising:
intaking air into a structure for cleansing of carbon dioxide;
charging a carbon capture fluid into a charged carbon capture fluid;
injecting said charged carbon capture fluid into said air within said structure;
capturing said charged carbon capture fluid on an air mixing component to capture said carbon dioxide from said air; and
separating said charged carbon dioxide from said air with a capture element having an opposing electrical charge to said carbon capture fluid.

26. The method of claim 25, further comprising:
reusing said carbon capture fluid, wherein said charged carbon capture fluid is collected and injected back into said structure.

27. The method of claim 25, wherein said air mixing component is a fan having an opposite polarity to said charged carbon capture fluid.

28. The method of claim 25, further comprising:
moving said air within said structure with an air stirring component.

29. The method of claim 28, wherein said air stirring component is electrically insulated.

30. The method of claim 28, wherein said air stirring component is a paddle.

31. The method of claim 28, wherein said air stirring component is a fan.

32. A method of capturing carbon comprising:
intaking air into an enclosure;
charging carbon capture fluid with an electrical charge to form a charged carbon capture fluid;
injecting said charged carbon capture fluid into said enclosure via a fluid entry component;
stirring said charged carbon capture fluid in said enclosure via an electrically insulated air stirring component;
capturing carbon dioxide from said air into said charged carbon capture fluid; and
circulating said charged carbon capture fluid holding said carbon dioxide through a release component holding an opposite charge from said charged carbon capture fluid to release said carbon dioxide into a holding reservoir.

33. The method of claim 32, further comprising:
releasing said carbon dioxide into an outer housing, wherein said carbon dioxide is released into said outer housing through centrifugal force.

34. The method of claim 32, wherein said release component comprises at least one fan configured to an opposite polarity of said charged carbon capture fluid to attract said charged carbon capture fluid.

35. The method of claim 32, further comprising:
reusing said carbon capture fluid, wherein said charged carbon capture fluid is collected and injected back into said structure.
